(19) United States
(12) Patent Application Publication
(10) Pub. No.: US 2016/0263549 A1
(43) Pub. Date: Sep. 15, 2016

(54) Surface Modified Carbon for Filtration Applications and Process for Making the Same

(71) Applicant: Marmon Water (Singapore) Pte. Ltd.

(72) Inventors: Vivekanand Gaur, Bangalore (IN); Vidya Ranganath, Bangalore (IN)

(21) Appl. No.: 14/722,839

(22) Filed: May 27, 2015

(30) Foreign Application Priority Data
Mar. 12, 2015 (IN) 810/MUM/2015

(51) Int. Cl. B01J 20/20; B01J 20/32; B01J 20/30

(52) U.S. Cl. CPC B01J 20/20; B01J 20/3085; B01J 20/3236; B01J 20/3078

(57) ABSTRACT

An enhanced, surface modified activated carbon for filter media, having a higher capacity for removing specific contaminants, such as H₂S, SO₂, Cl₂, CCl₄, NH₃, and HCHO, and a process for making the same. The surface of the activated carbon is modified with molybdenum and molybdenum-derivatives to enhance the activated carbon chemisorption capacity.

### BACKGROUND OF THE INVENTION

1. Field of the Invention

The present invention relates to activated carbon used for filter media, and specifically enhanced physisorption and chemisorption activated carbon having a modified surface enabling the filter media to have a higher capacity for specific contaminants, such as H₂S, SO₂, Cl₂, CCl₄, NH₃, and HCHO. The present invention further relates to the process for modifying the surface of the activated carbon with metal to enhance the chemisorption capacity of the filter media.

2. Description of Related Art

Activated carbon is a widely used adsorbent in the water and air treatment industries due to its exceptionally high surface area, well-developed internal microporosity and the presence of a wide spectrum of surface functional groups. As an inert, porous support material, activated carbon is capable of distributing chemicals on its large internal surface, thus making them accessible to reactants.

Typically, activated carbon is used to remove contaminants in water and/or air. Based on the type of carbon substrate used and the iodine value, which is the most commonly used term to represent the adsorption capacity (measured in iodine molecules in milligrams per gram of carbon sample), activated carbon has an affinity to remove a high volume of certain contaminants.

There remains a need to modify activated carbon to designate, or develop an affinity for, certain contaminants, thus promoting specific contaminant reduction. In order to increase the kinetics to establish this reduction, it is advantageous to modify carbon surfaces and create catalytic sites. When modified, such carbon is normally referred to as catalytic carbon.

Activated carbon, alumina, zeolites, and the like are widely used in filtration. These types of materials are sometimes referred to collectively as “active particulates” because of their configuration and innate ability to interact with fluids by sorbing (adsorbing and absorbing) components in the fluid.

Standard activated carbon is a porous material manufactured from carbonaceous raw material such as wood, peat, coconut shell, and coal. The activation process develops a myriad of pores of molecular dimensions within the carbon which together constitutes an enormous internal surface area and pore volume. Among porous sorbents, activated carbon is more advantageous due to its microporous texture, higher surface area, affinity to many contaminant molecules, and cost effectiveness. However, activated carbon has a limited capacity to remove certain types of gases and vapors; nor does it have the capacity for several specific air contaminants.

In general, activated carbon removes contaminant molecules by physisorption/physical forces. Physisorption or physical adsorption is the adsorption mechanism in which mainly Van der Waals forces (inter-molecular forces) are involved in attracting the molecules of the contaminants from the liquid or gases into the internal surface of the carbon atom matrix. The process of physisorption depends on the strength of the forces (the electrical attraction characteristics of both the adsorbate and adsorbent), and is related to several factors such as the molecular structure of the carbon medium, the functional groups present, the shape of the adsorbate, the pore structure of the adsorbent, pH, temperature, solvent-solute interactions, and pore-size distribution.

Activated carbon impregnated with copper, zinc, and silver has been proved to be effective in removal of certain gases. Whereas non-impregnated activated carbons are generally effective against limited toxic agents.

In contrast to physical attraction, which does not alter the adsorbate molecular structure, chemical adsorption results in changing the adsorbate molecular structure. These two phenomena are commonly referred to as physisorption (physical adsorption) and chemisorption (chemical adsorption).

The two mechanisms by which the chemicals are adsorbed onto activated carbon are either due to a greater “repulsion” from water, or a greater “attraction” to activated carbon. Activated carbon adsorption proceeds through three basic steps after adsorbates diffuse to the active site: a) substances adsorb to the exterior of the carbon surface; b) substances move into the carbon adsorption pore with the highest adsorption potential energy; or c) substances adsorb to the interior graphitic platelets of the carbon.

For example, U.S. Pat. No. 5,492,882 issued to Doughty, et al., titled “CHROMIUM-FREE IMPREGNATED ACTIVATED UNIVERSAL RESPIRATOR CARBON FOR ADSORPTION OF TOXIC GASES AND/OR VAPORS IN INDUSTRIAL APPLICATIONS,” discloses the use of activated carbon impregnated with molybdenum, copper, and zinc for the removal of noxious gases. U.S. Pat. No. 7,425,521 issued to Kaiser, et al., titled “STRUCTURED ADSORBENT MEDIA FOR PURIFYING CONTAMINATED AIR,” discloses a method for purifying air using a carbon based monolith structure impregnated with copper, silver, zinc, and molybdenum species and triethylenediamine. It also discloses the thermal treatment of the treated monolith structure.

There remains a need of improvement in the process and formulation of carbon based filters to develop higher sorption capacity carbon for air pollutants, and in particular AEBK gases/vapors.

### SUMMARY OF THE INVENTION

Bearing in mind the problems and deficiencies of the prior art, it is therefore an object of the present invention to provide carbon based filters having a higher sorption capacity carbon for air pollutants.

It is another object of the present invention to provide carbon based filters capable of removing specific contaminants, such as H₂S, SO₂, Cl₂, CCl₄, NH₃, and HCHO.

It is yet another object of the present invention to provide a process for making enhanced physisorption and chemisorption activated carbon having a modified surface that enables a filter media made of the activated carbon to have a higher capacity for contaminants.

The above and other objects, which will be apparent to those skilled in the art, are achieved in the present invention which is directed to a process for increasing the adsorption performance of activated carbon comprising: treating the activated carbon with an oxidizing agent to form treated carbon; impregnating the treated carbon with a Mo to form Mo-loaded treated carbon; heating the metal-loaded treated carbon within a gas purging atmosphere to form a resultant activated carbon having a surface including metal and metal-derivatives.

The activated carbon may include a coconut based carbon in granular or powdered form.

The treating step includes soaking the activated carbon in an acid solution while stirring; the sulfuric acid having a concentration of 1% to 15% v/w dissolved in water, wherein the water has a volume of approximately three times the activated carbon weight. The soaking is performed for approximately four hours.

The process further includes: decanting the activated carbon in the sulfuric acid solution; and drying the activated carbon at low temperature.

Drying the activated carbon at low temperature may include drying at a temperature of less than approximately 100° C. such that the activated carbon has a final moisture content of less than approximately 1%.

The impregnating step may include preparing an ammonium molybdate precursor solution;

and soaking the treated carbon in the precursor solution to form the metal-loaded treated carbon.

The ammonium molybdate precursor preferably has a concentration of approximately 5% to 20% v/w of the treated carbon, and is dissolved in water having a volume correlating to a weight of one-half to three times the treated carbon weight.

The water volume is determined as a function of water temperature including: one-half liter of water per kilogram of treated carbon for water temperature in the range of approximately 50° C. to 60° C.; or 3 L of water per kilogram of treated carbon for ambient water temperature.

The metal-loaded treated carbon is then decanted; and dried at low temperature.

Drying the metal-loaded treated carbon may include drying at a temperature of less than approximately 100° C. such that the metal-loaded treated carbon has a final moisture content of less than approximately 1%.

The step of heating the metal-loaded treated carbon within a gas purging atmosphere may include: heating the metal-loaded treated carbon under a nitrogen gas flow; and allowing the metal-loaded treated carbon to cool prior to use. The heating is performed for approximately three hours at approximately 500° C. in a retort/reactor.

In a second aspect, the present invention is directed to a process for increasing the adsorption performance of activated carbon comprising: treating the activated carbon with an oxidizing agent to form treated carbon, the treating including: soaking the activated carbon in sulfuric acid solution while stirring; decanting the activated carbon in the sulfuric acid solution; and drying the activated carbon at low temperature impregnating the treated carbon with molybdenum, the impregnating including: preparing an ammonium molybdate precursor solution; and soaking the treated carbon in the precursor solution to form a molybdenum-loaded treated carbon; decanting the molybdenum-loaded treated carbon; drying the molybdenum-loaded treated carbon at low temperature; heating the molybdenum-loaded treated carbon under a nitrogen gas flow to form a resultant activated carbon having a surface including molybdenum and molybdenum-derivatives; and allowing the molybdenum-loaded treated carbon to cool prior to use.

In a third aspect, the present invention is directed to a surface modified carbon filter media for removing contaminants in fluids, comprising: a base carbon impregnated with sulfur and oxygen containing functionalities; and catalytic sites formed a surface of the carbon filter media, including molybdenum (Mo) and molybdenum-derivatives; such that the carbon filter media has capacity for physisorption and chemisorption capable of removing specific contaminants, including H₂S, SO₂, Cl₂, CCl₄, NH₃, and HCHO.

An average crystallite size of the carbon is approximately 10.47 nm at a measured under X-ray diffraction at a full width half maxima (FWHM) of 0.83577.

The molybdenum (Mo) and molybdenum-derivatives are dispersed mainly in the form of molybdenum oxide (MoO₂).

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a comparative hydrogen sulfide (H₂S) adsorption for the enhanced physisorption and chemisorption carbon (EPC) versus raw (untreated) carbon;

FIG. 2 depicts a comparative H₂S adsorption breakthrough plot versus raw carbon, a sulfuric acid (H₂SO₄) treated sample, and an activated carbon (AC) impregnated with molybdenum (Mo);

FIG. 3 depicts a comparative ammonia (NH₃) adsorption breakthrough plot versus raw carbon and the enhanced physisorption and chemisorption carbon (EPC);

FIG. 4 depicts a comparative ammonia (NH₃) adsorption breakthrough plot by raw carbon, a sulfuric acid (H₂SO₄) treated sample, and activated carbon (AC) impregnated with molybdenum (Mo);

FIG. 5 depicts a comparative carbon tetrachloride (CCl₄) adsorption breakthrough plot by raw carbon and enhanced physisorption and chemisorption carbon;

FIG. 6 depicts a comparative sulfur dioxide (SO₂) adsorption breakthrough plot by raw carbon and enhanced physisorption and chemisorption carbon;

FIG. 7 depicts a comparative chlorine (Cl₂) adsorption breakthrough plot by raw carbon and enhanced physisorption and chemisorption carbon;

FIG. 8 depicts a comparative formaldehyde (HCHO) adsorption breakthrough plot by raw carbon and enhanced physisorption and chemisorption carbon; and

FIG. 9 depicts an X-ray diffraction pattern of the enhanced physisorption and chemisorption carbon of the present invention; and

FIG. 10 depicts a graph of the measured enhanced carbon demonstrating a crystallite size of approximately 10.47 nm at a FWHM of 0.83577 for 2θ of 36.85.

### DESCRIPTION OF THE PREFERRED EMBODIMENTS

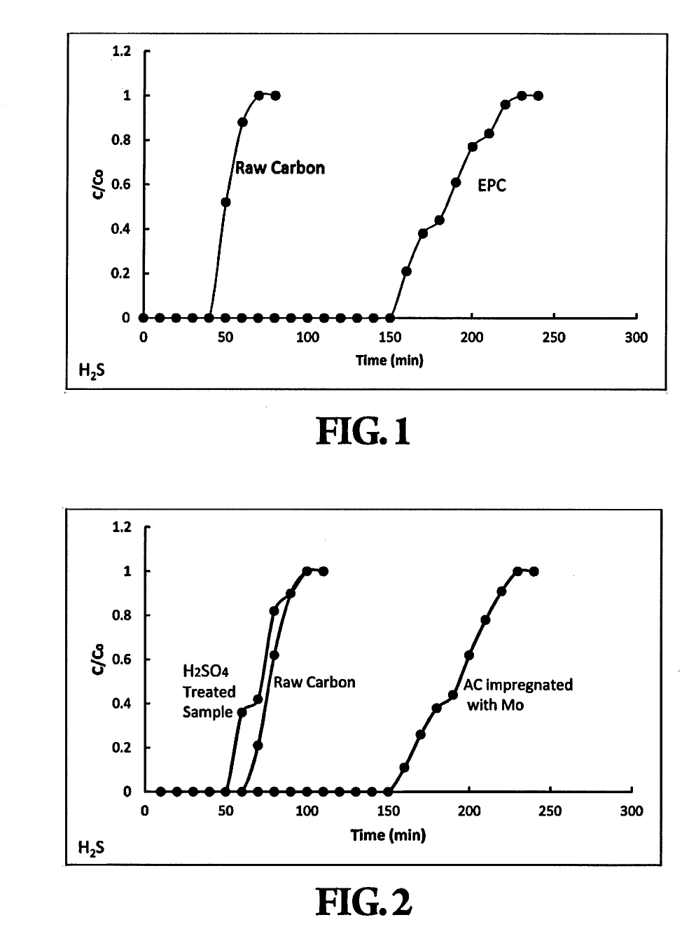

In describing the preferred embodiment of the present invention, reference will be made herein to FIGS. 1-10 of the drawings in which like numerals refer to like features of the invention.

The major toxic impurities present in water are inorganics, heavy metals (such as arsenic, lead and mercury), ionics (such as fluoride and cyanide), organic (such as phenol and trichloroethylene) and microbial contaminants. The major techniques applied for water purification include adsorption, ion exchange, reverse osmosis (RO) and intensive processes like chlorination and ozonation. Adsorption is one of the most effective and economic techniques. Activated carbon has been proven to be an effective adsorbent for the removal of a wide variety of contaminants from drinking water. As such activated carbon has remarkable affinity toward organic and inorganic contaminants in water; but to further enhance its adsorption capacity and make it more competitive toward specific impurities like metal species, the surface of the activated carbon is modified.

In general, the presence of acidic functional groups on activated carbon enhances their metal adsorptive capacities but these functional groups are unfavorable for the adsorption of organics like phenolic compounds. The factors that influence the activated carbon performance include: specific surface area, pore volume, pore-size distribution, and the nature of the activated carbon surface. The surface modifications result in the change in the surface reactivity, chemical, physical, and structural properties.

Although activated carbon is hydrophobic its adsorption capacity is limited. The adsorption capacity, in particular chemisorption, as well as catalytic activity of the carbon can be significantly enhanced by surface modification. It is in this context that the coconut shell based activated carbon may be surface modified by different ways to significantly higher capacity for specific contaminants including gas safety level classification standards, and specifically, H₂S, SO₂, Cl₂, CCl₄, NH₃, and HCHO, to name a few.

One such European filtering respiratory protection standard is EN 14387, which is the standard for providing the minimum requirements for gas and combination filters. This standard primarily demarcates filters into various types, identified or classified as A, B, E, K. Type A is used to protect against organic gases and vapors with a boiling point of greater than 65° C.; Type B is used to protect against inorganic gases and vapors; Type E is used to protect against sulfur dioxide and other acid gases and vapors; and Type K is used to protect against ammonia and organic ammonia derivatives.

The present invention increases the adsorption performance of carbon beyond physisorption, by surface modifying the carbon enabling it to also have the capacity for chemisorption. In this manner, the carbon is treated such that the surface and inner-pores are doped with different heteroatoms such as nitrogen, oxygen, sulfur, phosphorous, etc. These heteroatoms are present in the form of functional groups attached to the carbon basal plane. These charged functionalities enhance the affinity to target specific impurities which are difficult to be adsorbed only by physisorption. The functional groups of the treated carbon react with the impurities chelating to form stable compounds within the carbon. The present invention facilitates dispersing enormous charges on the carbon and within the pores of the carbon. Moreover, the unique surface modification treatment process ensures that the physical adsorption capacity of the carbon is still maintained.

The preferred process for developing enhanced physisorption and chemisorption carbon begins with an impregnation step. Surface impregnation is considered a chemical modification. The term impregnation is defined as the fine distribution of chemicals and metal particles in the pores of the activated carbon. Impregnation of activated carbon is performed to: a) optimize the catalytic properties of the activated carbon by promoting its built-in catalytic oxidation capability; b) promote synergism between the activated carbon and the impregnating agent; and c) boost the capacity of the activated carbon as an inert porous carrier.

The base carbon is impregnated with sulfur and oxygen containing functionalities by treating the carbon with oxidizing agents, such as H₂SO₄. Next, catalytic sites are developed by dispersing with a molybdenum (Mo) precursor, and then heating the treated carbon to activate the Mo sites and remove/evolve the counter molecules of the precursor. In this way, the invention provides a process of dual treated activated carbon that is capable of removing different types/classes of gaseous/vapor/air contaminants.

Within the treated carbon media, the molybdenum (or oxide) removes/isolates acidic gases and organic vapor, and sulfate removes alkaline/basic gases, like ammonia. Therefore, by selecting a suitable combination of concentration and heat treatment process conditions, an activated carbon with the ability to remove multiple gaseous contaminant and organic vapors can be prepared.

The variables which can affect the performance of the treated activated carbon include: 1) the concentration of the compounds used for treatment; 2) the starting material of the compounds used for impregnation; 3) the contact time between the solution to be treated and the activated carbon; 4) the temperature of reactor during heat treatment process; 5) the heating time in the reactor; and, 6) the volume of the solvent/H₂O used to dissolve the compounds used in treatment process.

In order to evaluate the effect of these variables, a number of samples were prepared and tested against surrogates of ABEK gas contaminants. The studies were conducted using various concentrations of sulfuric acid; ammonium molybdate; combination of concentration of sulfuric acid and ammonium molybdate; heating temperature; and heating time.

### Process Steps:

In the preferred embodiment, the process for making an enhanced physisorption and chemisorption carbon includes, in a first step, coconut shell based activated carbon. The most commonly used activated carbon in water purification is prepared from bituminous and anthracite coal and coconut shell-based raw materials. The activated carbon, which may be either in granular (GAC) or powder form, is treated with oxidizing agents, in particular sulfuric acid (H₂SO₄). The sulfuric acid, preferably in a concentration range of 1% to as high as 15% (v/w), is dissolved in water of a volume between two to three times the carbon weight to be treated. For example, for various mesh size of carbon (1 kg) batch, 1-15% v/w sulfuric acid is dissolved in 2-3 liters of water, depending on the particle size of carbon.

The carbon is then soaked for a suitable period of time, approximately four (4) hours in this acid solution under a stirring mechanism. After the four hour soaking/mixing/impregnation, the water/solution is decanted and carbon is filtered out and dried in an air oven at low temperature, generally at a temperature less than 100° C., to a final moisture content of less than one percent (1%).

The resultant acid treated carbon is rich in oxygen (O) and sulfur (S) content as compared to the initial carbon at the beginning of the process. The O and S elements are doped in the basal plane of the amorphous carbon structure in the form of different functional groups.

In a second step, the acid treated carbon is then impregnated with metal. For example, in an exemplary embodiment, the treated carbon is impregnated with molybdenum. In this instance, the Mo precursor is ammonium molybdate chiefly because of its solubility in water, and the ability to increase the solubility under temperature—using from ambient up to hot water (50-60° C.). The hot water results in a more effective impregnation of carbon.

Ammonium molybdate is introduced in a range between 5% and 20% w/w of carbon, and is dissolved in a water volume between one half (½) and three (3) times the carbon weight to be treated. The volume of the water is formulated as a function of the temperature of the water. For hot water (temperature in the range of approximately 50-60° C.), 0.5 L of water is required for 1 kg of the carbon batch, whereas for ambient temperature water, 3 L of water is required for 1 kg of carbon batch.

The carbon is soaked for 2 hours in this solution under stirring mechanism. The added metal is absorbed by the carbon, the left over water is decanted, and the carbon is filtered and dried in an air oven at a low temperature of less than 100° C. to a final moisture content lesser than 1%, resulting in a Mo-loaded activated carbon.

In a third step, the Mo-loaded activated carbon is heated to a high temperature, on the order of 500° C. for a period of time, preferably about three (3) hours, in a rotary stainless steel retort/reactor heated from the outside under a nitrogen gas purging. In this step, the ammonium molybdate decomposes to evolve ammonia and retain only Mo and Mo-derivatives on the carbon surface. The retort is generally rotating at a very slow speed (2-10 rpm) under a constant flow of nitrogen gas to maintain inert and evolving decomposed ammonia and other gases/vapors at high temperature. After the reaction, the heating is stopped, and when the temperature decreases to below 100° C., the enhanced physisorption and chemisorption carbon is unloaded and ready for use.

The carbon was characterized using the Brunauer, Emmett, and Teller (BET) method, pore size distribution was analyzed after modification, SEM analysis was performed for morphology, and X-ray diffraction (XRD) was performed for testing the crystalline phase of Mo.

### Test Results:

The surface modified/treated carbon was tested for dynamic adsorption tests in a packed column to establish its adsorption capacity for gases and vapors, including H₂S, SO₂, NH₃, and formaldehyde.

The performance of the surface modified/treated carbon is measured and demonstrated in terms of the breakthrough and saturation capacity during the dynamic adsorption experiments. Plots are provided to show the comparative performances for hydrogen sulfide (H₂S), sulfur dioxide (SO₂), ammonia (NH₃), carbon tetrachloride (CCl₄), Cl₂, and formaldehyde (HCHO) gases/vapors reduction in the air stream for the enhanced physisorption and chemisorption carbon and regular carbon.

As can be seen in the figures referenced herein, single treated (sulfuric acid or Molybdate) carbon demonstrates a higher capacity for one class of contaminants. For example, FIG. 1 depicts a comparative hydrogen sulfide (H₂S) adsorption for the enhanced physisorption and chemisorption carbon (EPC) versus raw (untreated) carbon. FIG. 2 depicts a comparative H₂S adsorption breakthrough plot versus raw carbon, a sulfuric acid (H₂SO₄) treated sample, and an activated carbon (AC) impregnated with molybdenum (Mo). For these comparative tests, the initial adsorption conditions were as follows: a hydrogen sulfide concentration in an influent gas stream of 10,000 ppm; a flow rate of 500 cc/min; a weight of 50 g; and ambient temperature (25° C.).

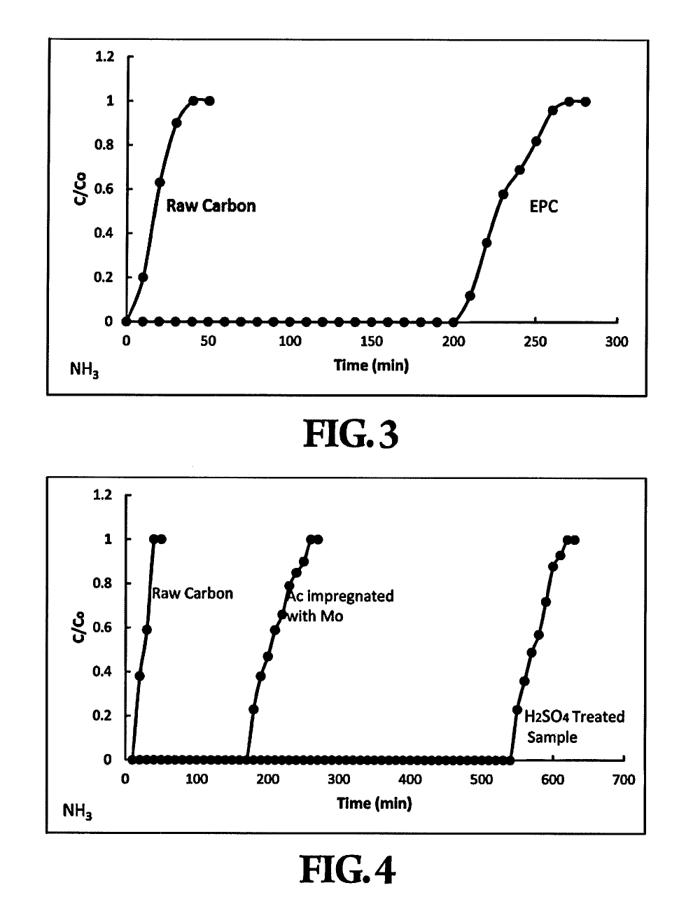

FIG. 3 depicts a comparative ammonia (NH₃) adsorption breakthrough plot versus raw carbon and the enhanced physisorption and chemisorption carbon (EPC). FIG. 4 depicts a comparative ammonia (NH₃) adsorption breakthrough plot by raw carbon, a sulfuric acid (H₂SO₄) treated sample, and activated carbon (AC) impregnated with molybdenum (Mo). For these comparative tests, the initial adsorption conditions were as follows: an ammonia (NH₃) concentration in an influent gas stream of 10,000 ppm; a flow rate of 300 cc/min; a weight of 50 g; and ambient temperature (25° C.).

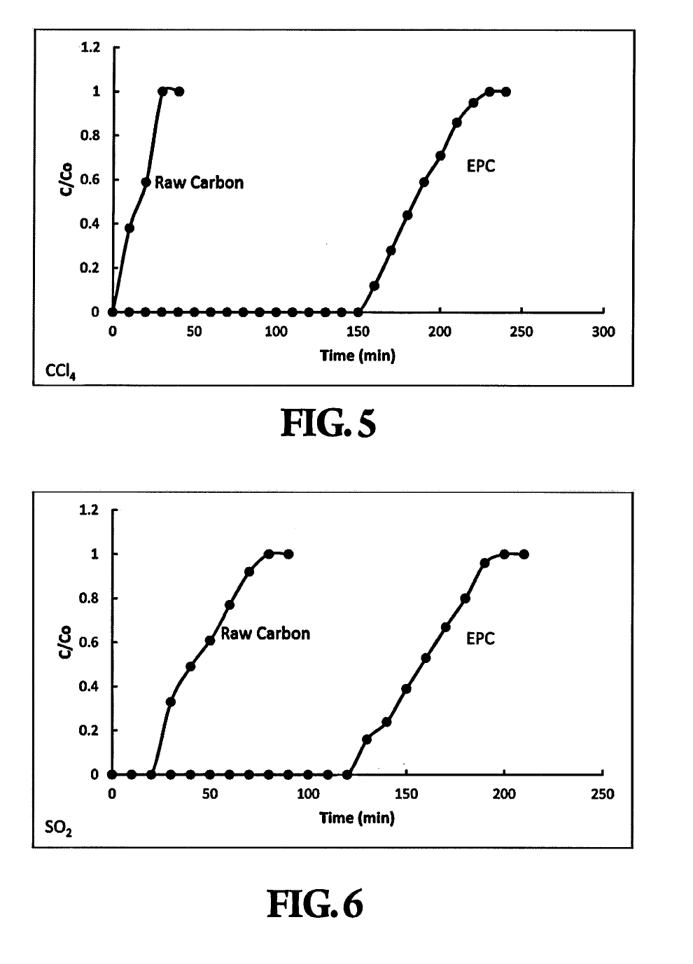

FIG. 5 depicts a comparative carbon tetrachloride (CCl₄) adsorption breakthrough plot by raw carbon and enhanced physisorption and chemisorption carbon (EPC). For this comparative test, the initial adsorption conditions were as follows: a carbon tetrachloride (CCl₄) concentration in an influent gas stream of 1,000 ppm; a flow rate of 200 cc/min; a weight of 50 g; and approximately ambient temperature (15-25° C.).

FIG. 6 depicts a comparative sulfur dioxide (SO₂) adsorption breakthrough plot by raw carbon and enhanced physisorption and chemisorption carbon (EPC). For this comparative test, the initial adsorption conditions were as follows: a sulfur dioxide (SO₂) concentration in an influent gas stream of 1,000 ppm; a flow rate of 500 cc/min; a weight of 50 g; and approximately ambient temperature (25° C.).

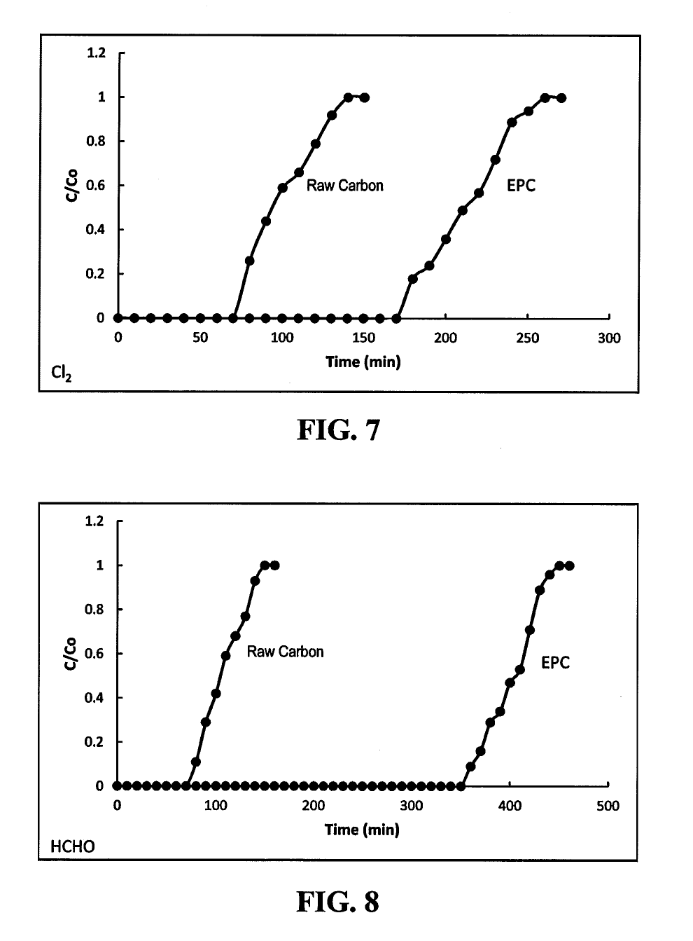

FIG. 7 depicts a comparative chlorine (Cl₂) adsorption breakthrough plot by raw carbon and enhanced physisorption and chemisorption carbon (EPC). For this comparative test, the initial adsorption conditions were as follows: a chlorine (Cl₂) concentration in an influent gas stream of 1,000 ppm; a flow rate of 500 cc/min; a weight of 50 g; and approximately ambient temperature (25° C.).

FIG. 8 depicts a comparative formaldehyde (HCHO) adsorption breakthrough plot by raw carbon and enhanced physisorption and chemisorption carbon (EPC). For this comparative test, the initial adsorption conditions were as follows: a formaldehyde (HCHO) concentration in an influent gas stream of 1,000 ppm; a flow rate of 800 cc/min; a weight of 10 g; and approximately ambient temperature (25° C.).

As noted by these charts, only sulfuric acid (H₂SO₄) treated carbon shows higher capacity for ammonia but it has decreased capacity for hydrogen sulfide (H₂S).

On the other hand, the Molybdate treated carbon exhibits a higher capacity for H₂S but less so for ammonia reduction. This due to the surface chemistry created by individual treatment. The H₂SO₄ treated carbon has got O and S functionalities which are enhancing the (selective) chemisorption for ammonia type gas molecules, whereas the molybdate functionalities are enhancing the chemisorption for H₂S type gas molecules. It is in this context that both treatments were attempted on same carbon to achieve the higher claims for the removal of all types of contaminants. As already described above the EPC carbon is having both types of chemical functionalities for the multiple claims. The results are as below.

Generally, a chemical activation process is employed by the present invention to manufacture enhanced, activated carbon. Raw activated carbon is treated with oxidizing agents, in particular sulfuric acid (H₂SO₄) dissolved in water, and soaked in this acid solution. The water is then decanted, and the carbon is filtered out and dried in an air oven at low temperature. The resultant acid treated carbon is rich in oxygen (O) and sulfur (S) content as compared to the initial carbon.

The acid treated carbon is then impregnated with metal, preferably with molybdenum, such as a Mo precursor of ammonium molybdate. The carbon is soaked in this solution, the left over water is decanted, and the carbon is filtered and dried at a low temperature.

The Mo-loaded activated carbon is then heated to a high temperature, under a continuing nitrogen gas flow or purging step. After the reaction, the heating is stopped, and when the temperature decreases the enhanced physisorption and chemisorption carbon is unloaded and ready for use.

### Analysis of Enhanced Physisorption and Chemisorption Carbon:

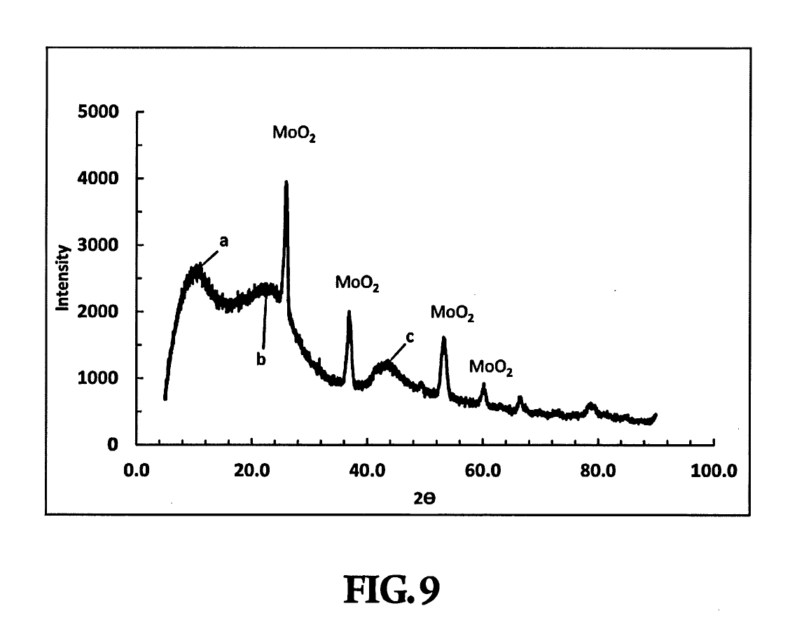

The enhanced physisorption and chemisorption carbon was analyzed under X-ray diffraction (XRD) to ascertain the type of Molybdenum phase and its crystallite size. The carbon samples were characterized by the XRD. The XRD pattern of the sample is depicted in FIG. 9. The metal crystallite size and the corresponding metal phase are characteristics which depend upon the sample preparation method, metal precursor type and loading, and the carbon support properties.

The obtained XRD pattern of the enhanced physisorption and chemisorption carbon indicates that the Mo is dispersed mainly in the form of molybdenum oxide (MoO₂) in monoclinic phase. The background broad peaks at 20 values of 10, 22.8 and 44.1 (a, b, c respective) refer to the amorphous structure of the activated carbon being used as the support for making the enhanced physisorption and chemisorption carbon.

A lower bound on the average crystallite size is calculated by using the Scherrer equation which relates the size of sub-micrometer particles or crystallites in a solid to the broadening of a peak in a diffraction pattern.

Dₚ=0.94λ/[β_{1/2} cos θ]
where,
   D_{P}=mean size of the ordered crystalline domains (crystallite size)
   β=line broadening at half the maximum intensity (FWHM)
   θ=Bragg angle (degrees)
   λ=X-ray Wavelength (angstroms)

The Scherrer Equation calculates the nano-crystallite size by XRD radiation of wavelength λ (nm) by measuring the full width at half maximum peaks (β) (in radians) located at any 2θ point in the pattern.

As can be seen from the Scherrer equation, the peak width due to the crystallite size varies inversely with crystallite size. That is, as the crystallite size gets smaller, the peak gets broader. The peak width varies with 2θ as cos θ. The crystallite size broadening is most pronounced at large angles 2θ. However, the instrumental profile width and microstrain broadening are also largest at large angles 2θ. Peak intensity is usually weakest at larger angles 2θ.

The shape factor or constant of proportionality used is 0.94, which is based in part on how the width is determined, the shape of the crystal, and the size distribution. For spherical crystals with cubic symmetry, the shape factor is 0.94 at FWHM.

Based on the above equation the lower bound for the average crystallite size for the treated carbon was calculated to be 10.47 nm at full width half maxima (FWHM) of 0.83577. FWHM represents the width of the diffraction peak, in radians, at a height half-way between background and the peak maximum.

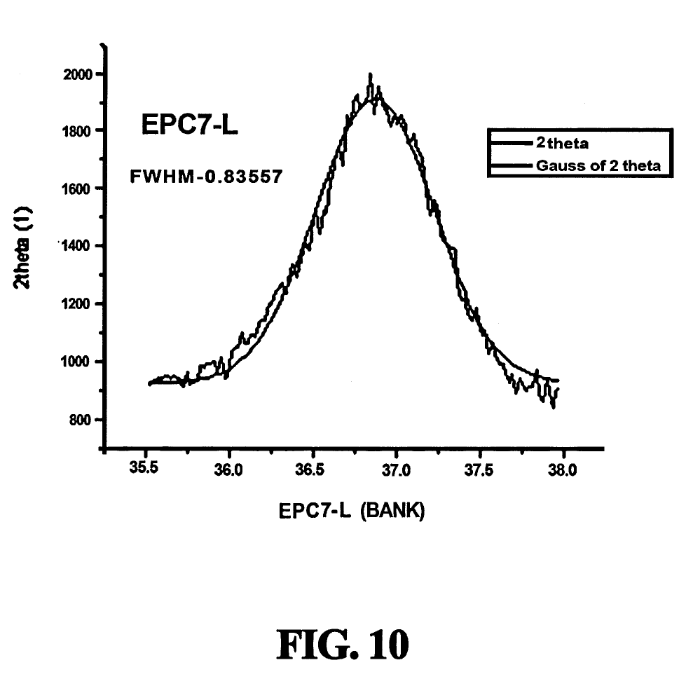

FIG. 10 depicts a graph of the measured carbon (EPC7-L) demonstrating a crystallite size of approximately 10.47 nm at a FWHM of 0.83577 for 20 of 36.85.

The adsorption performance of carbon is enhanced beyond physisorption, by surface modifying the carbon, enabling it to also have the capacity for chemisorption. The enhanced physisorption and chemisorption carbon is a surface modified activated carbon which is rich in oxygen (O) and sulfur (S) content, along with molybdenum and molybdenum-derivatives.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A process for increasing the adsorption performance of activated carbon comprising:
treating said activated carbon with an oxidizing agent to form treated carbon;
impregnating said treated carbon with a Mo to form Mo-loaded treated carbon; and
heating said metal-loaded treated carbon within a gas purging atmosphere to form a resultant activated carbon having a surface including metal and metal-derivatives.

2. The process of claim 1 wherein said activated carbon includes a coconut based carbon in granular or powdered form.

3. The process of claim 1 wherein said treating step includes soaking said activated carbon in an acid solution while stirring.

4. The process of claim 3 including soaking said activated carbon in a sulfuric acid solution, said sulfuric acid having a concentration of 1% to 15% v/w dissolved in water, wherein said water has a volume of approximately three times said activated carbon weight.

5. The process of claim 4 including soaking said activated carbon in said sulfuric acid solution for approximately four hours.

6. The process of claim 3 including:
decanting said activated carbon in said sulfuric acid solution; and
drying said activated carbon at low temperature.

7. The process of claim 6 wherein drying said activated carbon at low temperature includes drying at a temperature of less than approximately 100° C. such that said activated carbon has a final moisture content of less than approximately 1%.

8. The process of claim 1 wherein said impregnating step includes:
preparing an ammonium molybdate precursor solution; and
soaking said treated carbon in said precursor solution to form said metal-loaded treated carbon.

9. The process of claim 8 wherein said ammonium molybdate precursor has a concentration of approximately 5% to 20% v/w of said treated carbon, and is dissolved in water having a volume correlating to a weight of one-half to three times said treated carbon weight.

10. The process of claim 9 wherein said water volume is determined as a function of water temperature including:
one-half liter of water per kilogram of treated carbon for water temperature in the range of approximately 50° C. to 60° C.; or
three liters of water per kilogram of treated carbon for ambient water temperature.

11. The process of claim 8 including:
decanting said metal-loaded treated carbon; and
drying said metal-loaded treated carbon at low temperature.

12. The process of claim 11 wherein drying said metal-loaded treated carbon includes drying at a temperature of less than approximately 100° C. such that said metal-loaded treated carbon has a final moisture content of less than approximately 1%.

13. The process of claim 1 wherein said step of heating said metal-loaded treated carbon within a gas purging atmosphere includes:
heating said metal-loaded treated carbon under a nitrogen gas flow; and
allowing said metal-loaded treated carbon to cool prior to use.

14. The process of claim 13 wherein said heating is performed for approximately three hours at approximately 500° C. in a retort/reactor.

15. A process for increasing the adsorption performance of activated carbon comprising:
treating said activated carbon with an oxidizing agent to form treated carbon, said treating including:
soaking said activated carbon in sulfuric acid solution while stirring;
decanting said activated carbon in said sulfuric acid solution;
drying said activated carbon at low temperature;
impregnating said treated carbon with molybdenum, said impregnating including:
preparing an ammonium molybdate precursor solution;
soaking said treated carbon in said precursor solution to form a molybdenum-loaded treated carbon;
decanting said molybdenum-loaded treated carbon;
drying said molybdenum-loaded treated carbon at low temperature;
heating said molybdenum-loaded treated carbon under a nitrogen gas flow to form a resultant activated carbon having a surface including molybdenum and molybdenum-derivatives; and,
allowing said molybdenum-loaded treated carbon to cool prior to use.

16. A surface modified carbon filter media for removing contaminants in fluids, comprising:
a base carbon impregnated with sulfur and oxygen containing functionalities; and
catalytic sites formed a surface of said carbon filter media, including molybdenum (Mo) and molybdenum-derivatives;
such that said carbon filter media has capacity for physisorption and chemisorption capable of removing specific contaminants, including H₂S, SO₂, Cl₂, CCl₄, NH₃, and HCHO.

17. The surface modified carbon filter media of claim 16 wherein an average crystallite size of said carbon is approximately 10.47 nm at a measured under X-ray diffraction at a full width half maxima (FWHM) of 0.83577.

18. The surface modified carbon filter media of claim 16 wherein said molybdenum (Mo) and molybdenum-derivatives are dispersed mainly in the form of molybdenum oxide (MoO₂).
